(19) United States
(12) Patent Application Publication
(10) Pub. No.: US 2012/0121267 A1
(43) Pub. Date: May 17, 2012

(54) OPTICAL ADD-DROP MULTIPLEXER BRANCHING UNIT AND CORRESPONDING OPTICAL TRANSMISSION METHOD AND SYSTEM

(75) Inventors: Guozhong WANG, Shenzhen (CN); Liping MA, Beijing (CN); Ye WEN, Beijing (CN)

(73) Assignee: HUAWEI MARINE NETWORKS CO., LTD., Tianjin (CN)

(21) Appl. No.: 13/355,186

(22) Filed: Jan. 20, 2012

Related U.S. Application Data
(63) Continuation of application No. PCT/CN2010/073368, filed on May 31, 2010.

(30) Foreign Application Priority Data
Jul. 21, 2009 (CN) 200910088859.1

(51) Int. Cl. H04J 14/02

(52) U.S. Cl. 398/83

(57) ABSTRACT

Embodiments of the present invention provide an Optical Add-Drop Multiplexer (OADM) Branching Unit (BU) and the corresponding optical transmission method and system. The method includes: separating a part of optical signals of different wavelengths from two trunk fibers respectively, coupling the part of optical signals of different wavelengths, and transmitting the coupled optical signals to a branch station through a fiber; separating, according to wavelengths, optical signals that have different wavelengths and are transmitted by the branch station through a fiber, and then transmitting the optical signals to the two trunk fibers respectively; separating null-compensation light from the optical service signals transmitted through a fiber by the branch station to obtain the null-compensation light; coupling the null-compensation light with the part of optical signals that have different wavelengths and are respectively separated from the two trunk fibers, and transmitting the coupled optical signals to the branch station through a fiber.

### CROSS-REFERENCE TO RELATED APPLICATIONS

This application is a continuation of International Application No. PCT/CN2010/073368, filed on May 31, 2010, which claims priority to Chinese Patent Application No. 200910088859.1, filed on Jul. 21, 2009, both of which are hereby incorporated by reference in their entireties.

### FIELD OF THE INVENTION

The present invention relates to optical communication technologies, and in particular, to an Optical Add-Drop Multiplexer (OADM) Branching Unit (BU) and a corresponding optical transmission method and system.

### BACKGROUND OF THE INVENTION

An OADM BU is an optical branching unit in a submarine cable system, and implements a function of adding or dropping a part of fibers or a part of wavelengths of a main submarine cable to or from a branch. When the main submarine cable needs to be cut off due to a fault or maintenance, the part of fibers or the part of wavelengths added to or dropped from the branch can still be powered normally, which minimizes impact of the fault on a submarine cable service. Therefore, introduction of an OADM BU in the submarine cable system may implement mutual communication between multiple sites, greatly reduces the number of required submarine cables, and brings a high practical value.

The OADM BU does not separate a fiber of a trunk to a branch, and the OADM BU separates only a part of an optical service channel transmitted in the fiber on the trunk to the branch and transmits the part to a branch station through a downlink fiber of the branch. Meanwhile, the OADM BU couples an optical service signal transmitted by an uplink fiber of the branch into a trunk fiber, so that the optical service signal is transmitted together with on-hand optical service channels in the trunk fiber.

FIG. 1 is a schematic structural diagram of an OADM BU. In FIG. 1, 4 service channels from A to B enter the OADM BU; channels 1 and 3 are separated to a branch fiber, and new channels 1 and 3 transmitted on the branch are added to a trunk fiber so as to be further transmitted together with original channels 2 and 4 along the trunk fiber. A procedure of fiber transmission from B to A is similar to the foregoing.

The OADM BU is applicable to a scenario of point-to-point high-capacity service transmission, where service traffic is low on a branch node.

In the process of implementing the present invention, the inventor finds at least the following problems in the prior art:

In a branch submarine cable of the OADM BU, 4 fibers are required to implement a function of adding or dropping wavelengths of 2 trunk fibers.

The branch has few optical channel wavelengths, which are generally less than trunk wavelengths by 50%. An optical repeater on the branch needs to make adjustment according to the number of dropped wavelengths, which leads to complicated design of the optical repeater on the branch.

### SUMMARY OF THE INVENTION

Embodiments of the present invention provide an OADM BU and a corresponding optical transmission method and system to reduce complexity and a cost of the OADM BU and reduce a requirement on complexity of an optical repeater in a branch.

An OADM BU includes:

a first optical coupler, configured to couple a part of optical signals that have different wavelengths and are respectively separated from two trunk fibers, and transmit the optical signals to a branch station through a fiber; and

a first optical demultiplexer, configured to separate, according to wavelengths, optical service signals that have different wavelengths and are transmitted by the branch station through a fiber, and then transmit the optical service signals to the two trunk fibers respectively.

An optical transmission system includes a first trunk station, a second trunk station, a branch station, and an OADM BU.

Optical signals are reciprocally transmitted between the first trunk station and the second trunk station through two trunk fibers.

The branch station is configured to transmit optical service signals of different wavelengths to the OADM BU through a fiber.

The OADM BU includes:

a first optical coupler, configured to couple a part of optical signals that have different wavelengths and are respectively separated from the two trunk fibers, and transmit the optical signals to the branch station through a fiber; and

a first optical demultiplexer, configured to separate, according to wavelengths, optical signals that have different wavelengths and are transmitted by the branch station, and then transmit the optical signals to the two trunk fibers respectively.

An OADM BU includes:

a first optical demultiplexer, configured to receive null-compensation light transmitted through a fiber by a branch station, and transmit the null-compensation light to a first optical coupler; and

a first optical coupler, configured to couple a part of optical signals separated from a trunk fiber with the null-compensation light transmitted from the first optical demultiplexer, and transmit the coupled optical signals to the branch station through a fiber.

An optical transmission method of an OADM BU includes:

separating a part of optical signals of different wavelengths from two trunk fibers respectively, coupling the part of optical signals of different wavelengths, and transmitting the optical signals to a branch station through a fiber; and

separating, according to wavelengths, the optical signals that have different wavelengths and are transmitted by the branch station through a fiber, and then transmitting the optical signals to the two trunk fibers respectively.

As revealed in the technical solutions provided in the foregoing embodiments of the present invention, in the embodiments of the present invention, an optical coupler is used to couple a part of optical signals that have different wavelengths and are respectively separated from the two trunk fibers; an optical demultiplexer is used to separate, according to wavelengths, two optical signals that have different wavelengths and are transmitted by a branch station through a fiber; and therefore, only 2 fibers are required for implementing the function of adding or dropping channels of 2 trunk fibers, the complexity and the cost of the OADM BU are reduced, and reliability of the OADM BU is enhanced. Optical power of the optical service signals that are transmitted to the branch is controlled within a required range by controlling optical power of the null-compensation light.

### BRIEF DESCRIPTION OF THE DRAWINGS

To describe the technical solutions of the present invention more clearly, the following briefly describes the accompanying drawings involved in description of the embodiments of the present invention. Apparently, the described below show only some embodiments of the present invention, and persons of ordinary skill in the art can derive other accompanying drawings according to these accompanying drawings without any creative effort.

FIG. 1 is a schematic structural diagram of an OADM BU in the prior art;

FIG. 2 is a schematic structural diagram of an OADM BU according to a first embodiment of the present invention;

FIG. 3 is a schematic structural diagram of an OADM BU application system according to a second embodiment of the present invention; and

FIG. 4 is a schematic structural diagram of another OADM BU according to a fifth embodiment of the present invention.

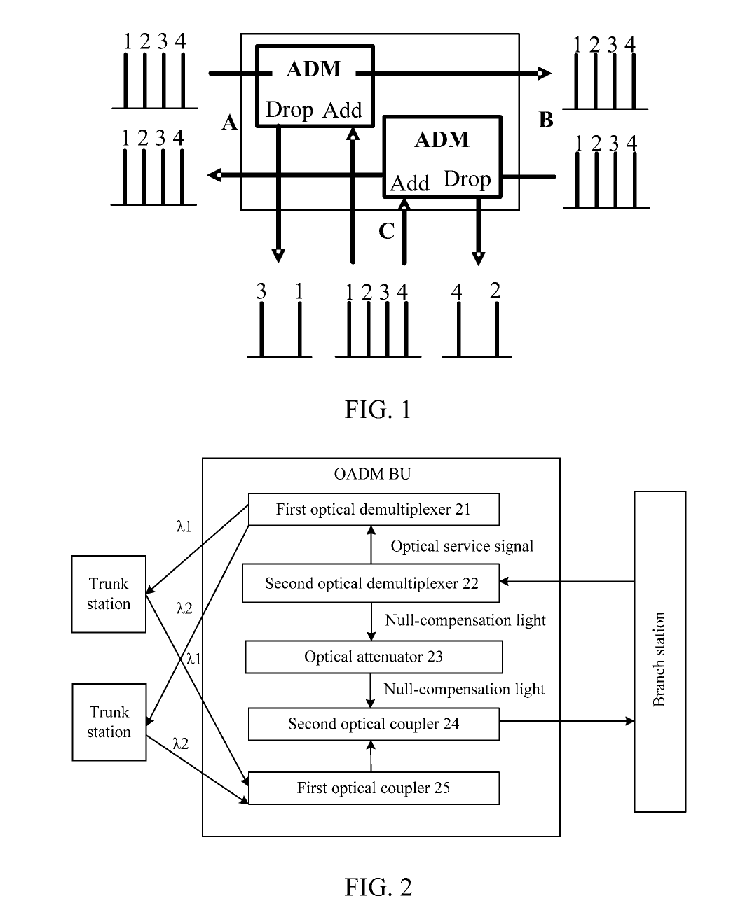

### DETAILED DESCRIPTION OF THE EMBODIMENTS

In the embodiments of the present invention, the OADM BU separates a part of optical signals of different wavelengths from two trunk fibers respectively, couples the part of optical signals of different wavelengths, and transmits the coupled optical signals to a branch station through a fiber; the OADM BU separates, according to wavelengths, optical signals that have different wavelengths and are transmitted by the branch station through a fiber, and then transmits two optical signals obtained after the separation to the two trunk fibers respectively.

Null-compensation light is separated from the optical service signals transmitted by the branch station through the fiber to obtain the null-compensation light; the null-compensation light is coupled with the part of optical signals that have different wavelengths and are respectively separated from the two trunk fibers, and the coupled optical signals are transmitted to the branch station through a fiber.

Further, according to a requirement on power of optical service signals in a branch fiber, power of the null-compensation light is adjusted. The null-compensation light whose power is adjusted is coupled with the part of optical signals that have different wavelengths and are respectively separated from the two trunk fibers, and the coupled optical signals are transmitted to the branch station through the fiber.

Further, the operation of adjusting the power of the null-compensation light is implemented by the OADM BU or the branch station.

For ease of understanding of the embodiments of the present invention, the following further describes several specific embodiments with reference to the accompanying drawings. The embodiments given herein shall not be construed as limitation on the present invention.

### Embodiment 1

FIG. 2 is a schematic structural diagram of an OADM BU provided in this embodiment. The OADM BU includes the following modules:

a first optical coupler 25, configured to couple a part of optical signals that have different wavelengths and are respectively separated from two trunk fibers, and transmit the optical signals to a branch station through a fiber, where for each of the two trunk fibers, an Add-Drop Multiplexer (ADM) may be used to separate a part of optical signals of one or multiple wavelengths, but optical signals separated from different trunk fibers have different wavelengths; and

a first optical demultiplexer 21, configured to separate, according to wavelengths, multiple optical service signals that have different wavelengths and are transmitted by the branch station through a fiber, and transmit optical service signals obtained after the separation to the two trunk fibers respectively, where the first optical demultiplexer may be implemented through the ADM.

The OADM BU may further include:

a second optical demultiplexer, configured to separate null-compensation light from the optical service signals transmitted by the branch station through the fiber, output null-compensation light obtained after the separation, and transmit optical service signals obtained after the separation to the first optical demultiplexer, where the second optical demultiplexer may be implemented through the ADM; and

a second optical coupler 24, configured to couple the null-compensation light that is output by the second optical demultiplexer with the part of optical signals that have different wavelengths and are respectively separated from the two trunk fibers, and transmit the coupled optical signals to the branch station through a fiber.

The OADM BU may further include:

an optical attenuator 23, configured to receive the null-compensation light that is output by the second optical demultiplexer, adjust power of the null-compensation light according to a requirement on power of optical service signals in a branch fiber, and transmit the null-compensation light whose power is adjusted to the second optical coupler.

### Embodiment 2

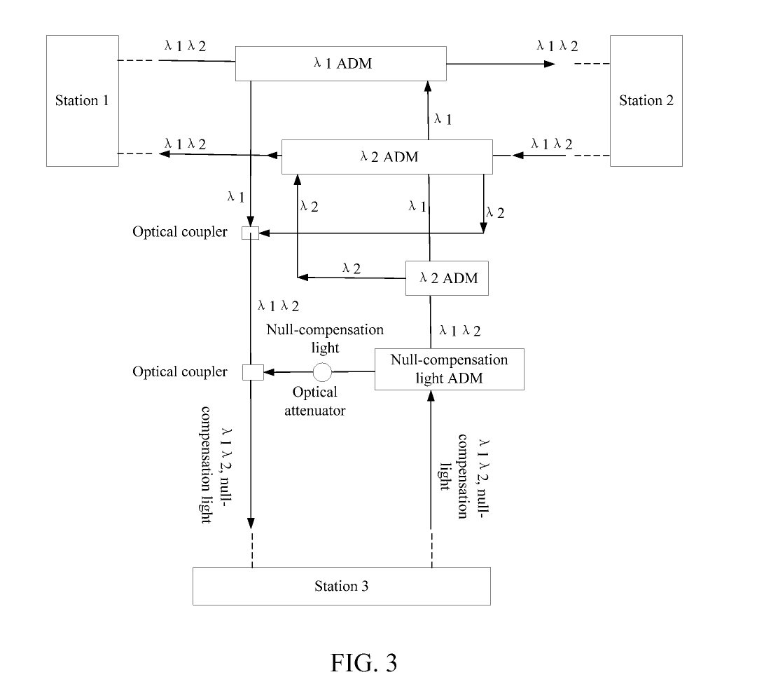

FIG. 3 is a schematic structural diagram of an OADM BU application system provided in this embodiment. The application system includes station 1, station 2, station 3, and an OADM BU. The OADM BU includes a λ1 ADM, two λ2 ADMs, a null-compensation light ADM, two optical couplers, and an optical attenuator.

A working procedure of the application system shown in FIG. 3 mainly includes the following:

In a practical application, the number of wavelengths that need to be added or dropped in the OADM BU is small and is basically less than the number of added or dropped wavelengths in a trunk by 10%. In this embodiment, the OADM BU separates different optical wavelengths of the trunk from left to right, and from right to left, respectively.

As shown in FIG. 3, in a fiber transmitted from left to right (from station 1 to station 2) of the trunk, after an optical signal enters the OADM BU, a λ1 channel is separated in the λ1 ADM; in a fiber transmitted from right to left (from station 2 to station 1) of the trunk, after an optical signal enters the OADM BU, a λ2 channel is separated in aλ2 ADM. The λ1 channel and the λ2 channel are coupled inside the OADM BU through an optical coupler, output through a branch downlink fiber to the outside of the OADM BU, and then transmitted through an optical repeater to station 3 in a branch along the fiber. In this way, one fiber is saved.

As shown in FIG. 3, a λ1 optical service signal and a λ2 optical service signal that are transmitted from the branch are output at station 3 by using a fiber, and the λ1 optical service signal and the λ2 optical service signal arrive at the other λ2 ADM inside the OADM BU. The other λ2 ADM separates the λ2 optical service signal from the received optical signal, uploads, through the foregoing λ2 ADM, the λ2 optical service signal to the trunk fiber in which transmission is performed from right to left; and uploads, through the foregoing λ1 ADM, the λ1 optical service signal to the trunk fiber that transmits a signal from left to right.

In this embodiment, only 2 fibers are required for implementing a function of adding or dropping 2 fiber channels of the trunk, which may satisfy a requirement of adding or dropping less than 50% of the wavelengths in a transmission system. The λ1 channel and the λ2 channel are used in a general sense, and may be extended to any number of channels so long as optical wavelengths of the channels are different from each other.

### Embodiment 3

In the OADM BU application system shown in FIG. 3, null-compensation light is transmitted from station 3 at the same time. The null-compensation light is light that transmits no service information. The null-compensation light occupies a certain width of spectrum, and has adjustable optical power. The null-compensation light and an optical service signal are transmitted in the same fiber, pass through a submarine optical repeater together, and are amplified. The null-compensation light and an uplink optical service signal of a branch pass through a branch uplink fiber and arrive at an OADM BU together.

In this embodiment, after the OADM BU receives the null-compensation light and the uplink optical service signal that are transmitted by station 3, the null-compensation light is separated from the branch uplink fiber through a null-compensation light ADM inside the OADM BU, and the null-compensation light ADM transmits a remaining optical service signal in the branch uplink fiber to a λ2 ADM. Afterward, power of the null-compensation light is adjusted as required through an optical attenuator, and the adjusted null-compensation light is coupled into the branch downlink fiber again through an optical coupler and is transmitted to station 3 together with the separated λ1 channel and λ2 channel through the optical repeater.

The optical repeater in the submarine cable system generally adopts a working mode with constant output optical power. Therefore, a ratio of the null-compensation light power to the total output optical power of the optical repeater is changed through the adjustment of the power of the null-compensation light. In this way, optical power of the optical service signal transmitted to the branch is controlled within a required range by adjusting power of the separated λ1 channel and λ2 channel that is output by the optical repeater.

In a practical application, the optical attenuator in the OADM BU may not be required and station 3 adjusts the optical power of the null-compensation light so as to adjust the power of the optical service signal in the uplink and downlink fibers of the branch to the required range.

In this embodiment, the optical power of the null-compensation light is controlled through the optical attenuator in the OADM BU or the station in the branch, and therefore, the optical power of the optical service signal transmitted to the branch is controlled within the required range by adjusting the power of the separated λ1 channel and λ2 channel output by the optical repeater.

### Embodiment 4

This embodiment of the present invention provides an optical transmission method of an OADM BU. A processing procedure of the method mainly includes the following:

Two trunk fibers are used to reciprocally transmit optical signals of different wavelengths between a first trunk station and a second trunk station. A part of optical signals of different wavelengths are respectively separated from the two trunk fibers, the part of optical signals of different wavelengths are coupled and transmitted to a branch station through a fiber. From each of the two trunk fibers, a part of optical signals of one or multiple wavelengths may be separated, but optical signals separated from different trunk fibers have different wavelengths.

Optical service signals that have different wavelengths and are transmitted by the branch station through a fiber are received. After being separated according to wavelengths, the optical service signals of different wavelengths are transmitted to the two trunk fibers respectively.

When the branch station additionally transmits null-compensation light to the OADM BU, the null-compensation light is separated from the optical service signals that are transmitted by the branch station through the fiber to obtain the null-compensation light and the optical service signals. Afterward, the null-compensation light is coupled with the part of optical signals that have different wavelengths and are respectively separated from the two trunk fibers, and the coupled optical signals are transmitted to the branch station through a fiber. The optical service signals obtained after the separation are separated according to wavelengths and then transmitted to the two trunk fibers respectively.

In a practical application, power of the null-compensation light needs to be adjusted according to a requirement on power of optical service signals in a branch fiber, for example, a requirement on power of an optical repeater in the branch fiber; the null-compensation light whose power is adjusted is coupled with the part of optical signals that have different wavelengths and are respectively separated from the two trunk fibers, and the coupled optical signals are transmitted to the branch station through a fiber. The operation of adjusting the power of the null-compensation light is implemented by the OADM BU or the branch station.

A first optical coupler 25 is configured to couple the part of optical signals that have different wavelengths and are respectively separated from two trunk fibers, and transmit the coupled optical signals to the branch station through a fiber. For each of the two trunk fibers, an Add-Drop Multiplexer (ADM) may be used to separate a part of optical signals of one or more wavelengths, but optical signals separated from different trunk fibers have different wavelengths.

A first optical demultiplexer 21 is configured to separate, according to wavelengths, multiple optical service signals that have different wavelengths and are transmitted by the branch station through a fiber, and transmit optical service signals obtained after the separation to the two trunk fibers respectively, where the first optical demultiplexer may be implemented through the ADM.

The OADM BU may further include:

a second optical demultiplexer, configured to separate null-compensation light from the optical service signals transmitted by the branch station through the fiber, output null-compensation light obtained after the separation, and transmit optical service signals obtained after the separation to the first optical demultiplexer, where the second optical demultiplexer may be implemented through the ADM; and

a second optical coupler 24, configured to couple the null-compensation light that is output by the second optical demultiplexer with the part of optical signals that have different wavelengths and are respectively separated from the two trunk fibers, and transmit the coupled optical channels to the branch station through a fiber.

The OADM BU may further include:

an optical attenuator 23, configured to receive the null-compensation light that is output by the second optical demultiplexer, adjust the power of the null-compensation light according to the requirement on the power of the optical service signals in the branch fiber, and transmit the null-compensation light whose power is adjusted to the second optical coupler.

### Embodiment 5

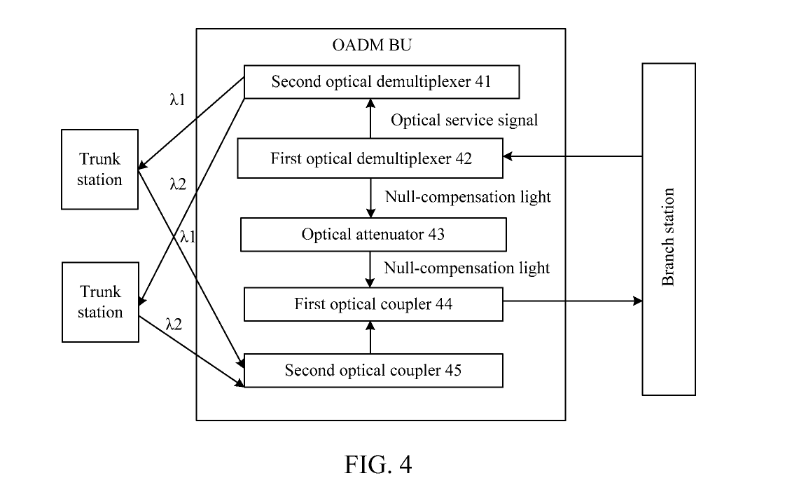

FIG. 4 is a schematic structural diagram of another OADM BU provided in this embodiment. The OADM BU includes the following modules:

a first optical demultiplexer 42, configured to receive null-compensation light transmitted through a fiber by a branch station, and transmit the null-compensation light to a first optical coupler; and

a first optical coupler 44, configured to couple a part of optical signals separated from a trunk fiber with the null-compensation light transmitted from the first optical demultiplexer, and transmit the coupled optical signals to the branch station through a fiber.

The OADM BU may further include:

a second optical coupler 45, configured to couple a part of optical signals that have different wavelengths and are respectively separated from two trunk fibers, and transmit the coupled optical channels to the first optical coupler through a fiber.

The first optical coupler 44 is further configured to: couple the null-compensation light transmitted by the first optical demultiplexer with the part of optical signals that have different wavelengths, are coupled, and are transmitted by the second optical coupler; and transmit the coupled optical signals to the branch station through a fiber.

The OADM BU may further include a second optical demultiplexer 41, and, in this case,

the first optical demultiplexer 42 is further configured to: separate the null-compensation light from optical service signals transmitted through a fiber by the branch station, transmit null-compensation light obtained after the separation to the first optical coupler, and transmit optical service signals obtained after the separation to the second optical demultiplexer.

The second optical demultiplexer 41 is configured to separate, according to wavelengths, the optical service signals transmitted by the first optical demultiplexer, and then transmit the optical service signals to the two trunk fibers respectively.

The OADM BU may further include:

an optical attenuator 43, configured to receive the null-compensation light that is output by the first optical demultiplexer, and adjust power of the null-compensation light according to a requirement on power of optical service signals in a branch fiber, and transmit the null-compensation light whose power is adjusted to the first optical coupler.

Persons of ordinary skill in the art may understand that all or part of the steps of the methods provided in the foregoing embodiments may be implemented by a program instructing relevant hardware. The program may be stored in a computer readable storage medium. When the program runs, the steps of the methods specified in the foregoing embodiments may be performed. The storage medium may be a magnetic disk, a Compact Disk Read-Only Memory (CD-ROM), a Read-Only Memory (ROM) or a Random Access Memory (RAM).

In conclusion, in the embodiments of the present invention, only 2 fibers are required for implementing the function of adding or dropping 2 fiber channels of the trunk, which may satisfy the requirement of adding or dropping less than 50% of the wavelengths in the transmission system.

In the embodiments of the present invention, the optical power of the null-compensation light is controlled through the optical attenuator in the OADM BU or the station in the branch, and therefore, the optical power of the optical service signal transmitted to the branch is controlled within the required range. In this way, the power of the optical service signals in the uplink and downlink fibers of the branch may be controlled in a simple passive mode, which reduces the number of required optical repeaters in the branch, reduces the complexity and the cost of the OADM BU, and enhances the reliability of the OADM BU. The embodiments of the present invention bring great cost-effectiveness to both the OADM BU itself and the entire transmission system equipped with the OADM BU.

The foregoing descriptions are merely specific embodiments of the present invention, but not intended to limit the protection scope of the present invention. Any modification, variation or replacement that can be easily derived by those skilled in the art shall fall within the protection scope of the present invention. Therefore, the protection scope of the present invention is subject to the appended claims.

What is claimed is:

1. An Optical Add-Drop Multiplexer (OADM) Branching Unit (BU), comprising:
a first optical coupler, configured to couple a part of optical signals that have different wavelengths and are respectively separated from two trunk fibers, and transmit the optical signals to a branch station through a fiber; and
a first optical demultiplexer, configured to separate, according to wavelengths, optical service signals that have different wavelengths and are transmitted by the branch station through a fiber, and then transmit the optical service signals to the two trunk fibers respectively.

2. The OADM BU according to claim 1, further comprising:
a second optical demultiplexer, configured to separate null-compensation light from the optical service signals transmitted by the branch station through the fiber, output null-compensation light obtained after the separation, and transmit optical service signals obtained after the separation to the first optical demultiplexer; and
a second optical coupler, configured to couple the mixed optical signals that are output by the first optical coupler with the null-compensation light that is output by the second optical demultiplexer, and transmit the coupled optical signals to the branch station through a fiber.

3. The OADM BU according to claim 2, further comprising:
an optical attenuator, configured to receive the null-compensation light that is output by the second optical demultiplexer, and adjust power of the null-compensation light according to a requirement on power of optical service signals in a branch fiber, and transmit the null-compensation light whose power is adjusted to the second optical coupler.

4. The OADM BU according to claim 2, wherein:
the first optical demultiplexer and the second optical demultiplexer are implemented through OADMs.

5. The OADM BU according to claim 3, wherein:
the first optical demultiplexer and the second optical demultiplexer are implemented through OADMs.

6. An optical transmission system, comprising a first trunk station, a second trunk station, a branch station, and an Optical Add-Drop Multiplexer (OADM) Branching Unit (BU), wherein:
optical signals are reciprocally transmitted between the first trunk station and the second trunk station through two trunk fibers;
the branch station is configured to transmit optical service signals of different wavelengths to the OADM BU through a fiber; and
the OADM BU comprises:
a first optical coupler, configured to couple a part of optical signals that have different wavelengths and are respectively separated from the two trunk fibers, and transmit the optical signals to the branch station through a fiber; and
a first optical demultiplexer, configured to separate, according to wavelengths, optical signals that have different wavelengths and are transmitted by the branch station, and then transmit the optical signals to the two trunk fibers respectively.

7. The optical transmission system equipped with the OADM BU according to claim 6, wherein the OADM BU further comprises:
a second optical demultiplexer, configured to separate null-compensation light from the optical service signals transmitted by the branch station through the fiber, output null-compensation light obtained after the separation, and transmit optical service signals obtained after the separation to the first optical demultiplexer; and
a second optical coupler, configured to couple the mixed optical signals that are output by the first optical coupler with the null-compensation light that is output by the second optical demultiplexer, and transmit the coupled optical signals to the branch station through a fiber.

8. The optical transmission system equipped with the OADM BU according to claim 7, wherein:
the branch station is further configured to adjust power of the null-compensation light according to a requirement on power of optical service signals in a branch fiber, and transmit the null-compensation light whose power is adjusted and the optical service signals of different wavelengths to the OADM BU through a fiber.

9. An Optical Add-Drop Multiplexer (OADM) Branching Unit (BU), comprising:
a first optical demultiplexer, configured to receive null-compensation light transmitted through a fiber by a branch station, and transmit the null-compensation light to a first optical coupler; and
a first optical coupler, configured to couple a part of optical signals separated from a trunk fiber with the null-compensation light transmitted from the first optical demultiplexer, and transmit the coupled optical signals to the branch station through a fiber.

10. The OADM BU according to claim 9, further comprising:
a second optical coupler, configured to couple a part of optical signals that have different wavelengths and are respectively separated from two trunk fibers, and transmit the optical signals to the first optical coupler through a fiber; and
the first optical coupler, further configured to: couple the null-compensation light transmitted by the first optical demultiplexer with the part of optical signals that have different wavelengths, are coupled, and are transmitted by the second optical coupler; and
transmit the coupled optical signals to the branch station through a fiber.

11. The OADM BU according to claim 9, wherein:
the OADM BU further comprises a second optical demultiplexer;
the first optical demultiplexer is further configured to: separate the null-compensation light from optical service signals transmitted through a fiber by the branch station, transmit null-compensation light obtained after the separation to the first optical coupler, and transmit optical service signals obtained after the separation to the second optical demultiplexer; and
the second optical demultiplexer is configured to separate, according to wavelengths, the optical service signals transmitted by the first optical demultiplexer, and then transmit the optical service signals to the two trunk fibers respectively.

12. The OADM BU according to claim 9, further comprising:
an optical attenuator, configured to receive the null-compensation light that is output by the first optical demultiplexer, and adjust power of the null-compensation light according to a requirement on power of optical service signals in a branch fiber, and transmit the null-compensation light whose power is adjusted to the first optical coupler.

13. The OADM BU according to claim 10, further comprising:
an optical attenuator, configured to receive the null-compensation light that is output by the first optical demultiplexer, and adjust power of the null-compensation light according to a requirement on power of optical service signals in a branch fiber, and transmit the null-compensation light whose power is adjusted to the first optical coupler.

14. The OADM BU according to claim 11, further comprising:
an optical attenuator, configured to receive the null-compensation light that is output by the first optical demultiplexer, and adjust power of the null-compensation light according to a requirement on power of optical service signals in a branch fiber, and transmit the null-compensation light whose power is adjusted to the first optical coupler.

15. An optical transmission method of an Optical Add-Drop Multiplexer (OADM) Branching Unit (BU), comprising:
separating a part of optical signals of different wavelengths from two trunk fibers respectively, coupling the part of optical signals of different wavelengths, and transmitting the optical signals to a branch station through a fiber; and
separating, according to wavelengths, the optical signals that have different wavelengths and are transmitted by the branch station through a fiber, and then transmitting the optical signals to the two trunk fibers respectively.

16. The optical transmission method of the OADM BU according to claim 15, further comprising:
separating null-compensation light from optical service signals transmitted through a fiber by the branch station to obtain the null-compensation light; and
coupling the null-compensation light with the part of optical signals that have different wavelengths and are respectively separated from the two trunk fibers, and transmitting the coupled optical signals to the branch station through a fiber.

17. The optical transmission method of the OADM BU according to claim 16, further comprising:
adjusting power of the null-compensation light according to a requirement on power of optical service signals in a branch fiber, coupling the null-compensation light whose power is adjusted with the part of optical signals that have different wavelengths and are respectively separated from the two trunk fibers, and transmitting the coupled optical signals to the branch station through a fiber.

18. The optical transmission method of OADM BU according to claim 17, wherein:
the operation of adjusting the power of the null-compensation light is implemented by the OADM BU or the branch station.
